(19) United States
(12) Patent Application Publication
(10) Pub. No.: US 2005/0216518 A1
(43) Pub. Date: Sep. 29, 2005

(54) Database management system with persistent, user-accessible bitmap values

(75) Inventors: Ying Hu, Nashua, NH (US); Timothy Chorma, Nashua, NH (US); Seema Sundara, Nashua, NH (US); Eugene Inseok Chong, Concord, MA (US); Souripriya Das, Nashua, NH (US); Jagannathan Srinivasan, Nashua, NH (US)

Correspondence Address: GORDON E NELSON;PATENT ATTORNEY, PC, 57 CENTRAL ST, PO BOX 782, ROWLEY, MA, 01969, US

(73) Assignee: Oracle International Corporation

(21) Appl. No.: 10/810,756

(22) Filed: Mar. 26, 2004

(51) Int. Cl. G06F 17/30; G06F 17/00

(52) U.S. Cl. 707/200; 707/100

(57) ABSTRACT

A database management system that has bitmap values in which set bits in a representation of a bitstring specify a set of objects whose definitions are built into the database management system. The database management system further includes user-accessible operations on the bitmap values. The bitmap values are represented by means of a mapping specifier that specifies a range of the set of objects and a representation of a string of bits that has been mapped onto the set of object specified by the range specifier. The representation of the string of bits may be compressed. Bitmap operations on the values may alter the range specifier, the size of the string of bits, or individual bits in the string of bits. The objects represented by the bitmap values may be objects in the database management system or objects external thereto. An example of bitmap values of the first kind are bitmap values representing sets of rowids. rowid bitmap values may be used to make a user-defined index of attribute values for any set of objects contained in fields in the database management system. An example of bitmap values of the second kind are bitmap values representing sets of electronic product codes. ePC bitmap values may be used in any application where a compact representation of a set of ePC codes is desired.

### BACKGROUND OF THE INVENTION

1. Field of the Invention

The present invention relates generally to database management systems and more particularly to the use of bitmap values in a database management system to represent subsets of a set of objects.

2. Description of Related Art

The following Description of related art will begin with a description of the built-in indexing systems provided by modern database management systems and will then describe how modem database management systems further permit users to define their own kinds of indexing systems for use by the database management system.

Indexes Generally

Any large collection of information is made much more useful by the inclusion of an index. For example, if a history of the American Revolutionary War has an index and a reader of the history is interested in General Henry Knox's role in forcing the British to evacuate Boston on Mar. 17, 1776, the reader need only look up “Knox, Henry” in the index, where the reader will find a list of the pages in the history book on which General Knox is mentioned. Without the index, the reader would have to scan large portions of the book to find what he or she was looking for. In the terms used in the following discussion, the history of the American revolution defines a set of information; often a reader of the history is interested only in a portion of that set of information; the portion is termed a subset of the information. Thus, what the history's index does is specify the locations of subsets of the information and thereby speed up the user's access to the indexed subsets.

Built-In Indexing Systems

Database management systems exist to manage and provide access to large collections of information, and as one would expect, database management systems have indexes. In relational database management systems, the collections of information are organized as tables. A database table has a number of columns and may have a number of rows. Each row has a field corresponding to each column. The value of the field corresponding to a column has the kind of value required for the column. For example, the following simple table Employees has four columns and two rows:

| Rowid | Name | Gender | Job_Title |
|---|---|---|---|
| 1 | Smith | F | Manager |
| 2 | Jones | M | Laborer |

Each row represents an employee. The column Rowid is a built-in column whose fields contain a database-system assigned row identifier for each row in the table. The row identifier uniquely identifies the row in the database management system. The fields corresponding to the column Name contains the name of the employee represented by the row. The fields corresponding to Gender contain the employee's biological gender; the fields corresponding to Job_Title, finally, contain the employee's job title. To obtain information from the table, the user provides a query to the database management system which describes the rows from which information is to be fetched and the information to be fetched from those rows. For example, the query
SELECT Name FROM Employees WHERE Job_Title=Manager
   selects the row from Employees whose job title field has the value Manager, that is, the row whose rowid is 1, and returns the value of the Name field from that row, that is, Smith. In terms of the introductory discussion, the query specifies a subset of the set of information contained in Employees and returns the specified subset.

While making an index for Employees is hardly worthwhile, one can be made. Indeed, if Employees were a 10,000 row table, making an index would definitely be worth while. For example, an index by the values of the Name column on Employees would look like this: Jones, 2; Smith, 1. The index has the names in alphabetical order and each name is followed by the rowid for the row the name occurs in. Modem database management systems such as the Oracle 9i® database management system produced by Oracle Corporation, Redwood City, Calif., contain a built-in indexing facility which permits users to specify indexes like the name index in the above example. A specification for such an index in the database management system looks like this:
CREATE INDEX employee_name_index ON Employees(Name)

In response to the specification, the database management system creates the index, updates the index when the table to which it belongs changes, and uses the index to speed up queries on the table. For example, given the above index and the query
SELECT Job Title FROM Employees WHERE Name=Smith
   the database management system would use the index to determine that the row for Smith was row 1, instead of reading down the table until it found the row whose Name field had the value Smith. The use of the index in the query is thus exactly analogous to its use by the human reader of the history book.

One of the kinds of indexes produced by modem database management systems is a bitmap index. A bitmap is a sequence of bits which has been mapped to a set of objects. Each bit corresponds to one of the objects in the set. A bitmap value is a bitmap in which bits have been set to specify a subset of the set of objects. When an object belongs to the subset, the bit corresponding to the object in the bitmap value is set. In the bitmap indexes used in modem database management systems, the bitmap has been mapped to the set of rowids representing the rows in a table. For example, there are two rows in the table Employees, so the set of rowids has two members and the bitmap has two bits. In our example, the first bit of the bitmap is mapped to rowid 1 and the second to rowid 2. Because each bit in the bitmap is mapped to a rowid in the table, bitmap values can be used as indexes into the table. For instance, a bitmap value that represents a set of rowids in the table Employees can be used to indicate all rows in the table that have the value M in the Gender field. In such a bitmap value, the bit representing a given rowid of the table has the value 1 when M is present in the row's Gender field and otherwise 0. The example bitmap value for the value M in the Gender field in Employees is 0,1. The value M is termed the key of the bitmap value. To locate the row with the value M, the database management system consults the bitmap value for that key and determines from the fact that the 1 is the second bit in the bitmap value that the row with the value is the row having rowid 2.

The Oracle 9i database management system permits the user to specify that a bitmap index be created for a column of a table. The database management system responds to such a specification by making a bitmap index that includes a bitmap value for each possible value of the fields of the column. For example, fields in the Gender column may have only two values: M and F. Thus, for this column, the database management system would build two bitmap values, one for the key M and the other for the key F. A specification that would cause the Oracle 9i database management system to build such and index is the following:
CREATE BITMAP INDEX Gender_index ON Employees(Gender)

The bitmap value for the M key is 0,1, as set forth above; the bitmap value for the F key is 1,0. The bitmap value for the M key thus specifies the subset of the rows of the table Employees that contains the row having rowid 2, while the bitmap value for the F key specifies the subset that contains the row having rowid 1.

The advantages of the bitmap index are that it takes up very little space and that logical operations such as AND, OR, and NOT in queries can be performed very rapidly on fields with bitmap indexes by performing the logical operations on the bitmap values. For example, the query
SELECT Name FROM Employees WHERE Gender=‘M’ OR Gender=‘F’
   would OR the bitmap value for Gender whose key is M, namely 1,0, with the bitmap value for Gender whose key is F, namely 0,1, to produce the bitmap value 1,1, which specifies that every row in Employees is to be selected. The built-in indexing systems provided by the Oracle 9i database management system are described in detail beginning at the section Indexes on page 10-28 of Oracle 9i Database Concepts, Release 2, published by Oracle Corporation in 2002 and available from Oracle Corporation as part number A96524-01. The description is incorporated into the present patent application by reference.
   User-Defined Indexing Systems

In the database management systems for which the built-in indexing systems were designed, the values contained in the fields of the database management system's tables had to belong to one of a small number of built-in data types. The built-in data types typically included character data types for names and words, decimal data types for decimal numbers, integer data types for whole numbers, and data types of system values used in the database management system's metadata, that is, the data which defines the tables. In the example table Employees, the rowids are such system data The data in the other fields has character data types. More recently, database management systems have included arrangements which permit the user to define his or her own data types and use values having those data types in fields in the database management system's tables. The user-defined data types are employed in a domain in which the user is interested. For example, a user interested in photographs might define data types suitable for that domain. An example would be a data type Photograph. At a minimum, the definition of Photograph specifies how values of type Photograph are represented in the database management system. The definition can also specify operations that may be performed on values of the type. For instance, if the domain requires that photographs be compared, the definition may specify a Like operation that compares two photographs and returns a result that is a measure of similarity. Finally, the definition can specify an indexing system for values of type Photograph. To do this, the user must specify how the index is defined, how it is maintained, and how it is read. The mechanisms used for defining user-defined types and operations on them in the Oracle 9i database management system are described in Oracle 9i Data Cartridge Developer's Guide, Release 2 (9.2), Part No. A96595-01, available from Oracle Corporation. The discussion of user-defined indexing is contained in Chapter 7, Building Domain Indexes. The entire reference is hereby incorporated into the present application by reference.

Limitations of Built-in and User-defined Indexing Systems

The built-in indexing systems are easy to use and efficient, but the number of kinds of indexes is limited. For example, the Oracle 9i database management system currently provides the following built-in indexing schemes:
B-tree indexes
B-tree cluster indexes
Hash cluster indexes
Reverse key indexes
Bitmap indexes
Bitmap Join Indexes

Further, there are certain kinds of built-in data types that cannot be indexed using these indexing schemes and the built-in indexing schemes have only limited use with user-defined types. A final disadvantage of the built-in indexing schemes is that the user has very little control over the manner in which the database management system constructs the indexes and no access to the internal indexing data.

For example, with bitmap indexes, the system always constructs a bitmap for every possible value of the field whose values are being used as keys. The system further requires that the values used as keys are mutually exclusive and that values in the column for which the index is being made belong to system-defined types. There are, however, many situations in which the user is interested in indexes only for certain key values or indexes for overlapping ranges of values or in indexes for user-defined types and the built-in bitmap indexes are simply not useful in those situations. Moreover, the primitive operations that the database management system employs to make and manipulate bitmap values are never accessible to the user. For example, the user cannot make a bitmap value that represents the rowids returned by a user-defined query.

A user can of course make a user-defined indexing system that uses any indexing scheme that is useful for the domain of the data being indexed. The drawback of such a user-defined indexing scheme is that the user must make the considerable effort required to design and program the indexing scheme. One of the things that increases the effort required to design and program such index schemes is the unavailability of indexing primitives to the programmer.

As noted above, bitmap values are used in indexing schemes because they are compact representations of sets of objects. Use of bitmap values in other situations which require compact representations of sets of objects is not possible because programmers using the database management system have access neither to the bitmap values themselves nor to primitive operations for them.

The MySQL open source relational database system has a SET built-in data type which is used to represent sets of up to 64 user-defined objects. A value of the SET type represents a subset of a particular user-defined set of objects, and the subset is represented by a bitmap value which is mapped onto the particular user-defined set of objects and has a bit set for each object that belongs to the subset. MySQL provides primitive operations for values of the SET type, but the limitation of the number of objects in the set to 64 renders MySQL set types useless for applications which require bitmap values that are capable of representing subsets of large sets of objects. One large class of such applications is of course bitmap indexes.

As can be seen from the foregoing, a database management system in which programmers had access to bitmap values specifying subsets of large sets of values and to primitive operations for the bitmap values would greatly increase the number of situations in which bitmap indexes could be employed, would permit their use with objects having user-defined classes, and would permit the use of bitmap values generally to represent subsets of large sets of objects. It is an object of the invention disclosed herein to provide such a database management system.

### SUMMARY OF THE INVENTION

The object of the invention is achieved by means of an improved database management system. The database management system has bitmap values wherein set bits in a representation of a bitstring specify a set of objects whose definitions are built into the database management system. The database management system also has user-accessible operations on the bitmap values. The operations include at least one operation from the following:
a set-to-bitmap operation in which a bitmap value is derived from a given set of the objects;
   the set-to-bitmap operation where the derived value is a new bitmap value that specifies the objects in the given set;
   the set-to-bitmap operation where the derived value is a preexisting bitmap value which now further specifies the objects in the given set; and
   the derived bitmap value is a preexisting bitmap value which now no longer specifies any objects in the given set.
a bitmap-to-set operation in which the set of objects specified in a given bitmap value is derived from the given bitmap value;
a bitmap-to-count operation in which the number of objects in the set specified by a given bitmap value is derived from the given bitmap value;
an existence operation in which a value representing the logical value TRUE is returned when a given object belongs to the set of objects represented by a given bitmap value;
logical operations on the bitstrings represented by bitmap values, the logical operations including AND, OR, XOR, and MINUS operations;
a bitmap EQUALS operation in which a value representing the logical value TRUE is returned when two bitmap values specify the same set of objects; and
a bitmap assignment operation in which a bitmap source value is assigned to a target bitmap data item.

In other aspects of the invention, the bitmap values are persistent in the database management system and may be the values of fields in tables in the database management system. The bitstrings in the bitmap values may be compressed.

The objects whose definitions are built into the database management system may be identifiers for other objects that exist in the database management system. The identifiers may be row identifiers and the row identifiers represented by a bitmap value may have been returned by a user-defined query executed in the database management system. The objects whose definitions are built into the data base management system may also be identifiers for other objects that exist outside the database management system. In one aspect of the invention, the identifiers are electronic product codes for product items.

In another aspect, the invention is a bitmap value employed in a database management system to represent a first set of first objects. The first objects are external to the database management system. Members of the first set of objects are mapped onto members of a second set of second objects that is defined in the database management system. The bitmap value includes a mapping specifier and a representation of the string of bits. The mapping specifier maps the represented string of bits to a subset of the second set. A bit is set in the represented string of bits when the member of the second set that is mapped to the bit has a member of the first set mapped thereto.

The second set of objects may be ordered and the order of the members in the set may correspond to the values of the members. In such a situation, the mapping specifier specifies one or more ranges of the values of the members of the second ordered set and the representation of the string of bits represents strings of bits corresponding to the ranges. The ranges may be specified by start values and end values and/or by prefix values. Certain of the bitmap operations may alter the range specifier and the representation of the bitstring corresponding thereto.

In a further aspect, the invention is a bitmap value that represents a first subset of the row identifiers defined in the database management system. The bitmap value includes a mapping specifier and a bitstring representation and the first subset of the rowids is returned by a user-defined query executed by the database management system. Bitmap values that represent subsets of row identifiers may be used to construct an index by attribute value for any set of objects which can be stored in the tables of a database management system.

In an additional aspect, the invention is a representation of a set of electronic product codes. The representation includes a range specifier that specifies a range of electronic product codes that includes the members of the set and a bitstring representation that is mapped to the range specified by the range specifier. The representation can be used wherever a space-efficient representation of a set of electronic product codes is required.

Other objects and advantages will be apparent to those skilled in the arts to which the invention pertains upon perusal of the following Detailed Description and drawing, wherein:

### BRIEF DESCRIPTION OF THE DRAWING

FIG. 1 is a conceptual overview of a user-defined index made using the bitmap values of the invention;

FIG. 2 is an overview of the technique used to represent bitmap values in a preferred embodiment;

FIG. 3 shows conversion operations that may be performed on bitmap values;

FIG. 4 shows an object-exists operation that may be performed on bitmap values;

FIG. 5 shows logical operations that may be performed on bitmap values;

FIG. 6 shows operations for inserting bits representing objects into bitmap values and deleting bits representing objects from bitmap values;

FIG. 7 shows the metadata objects in a database management system in which the invention is implemented;

FIG. 8 shows electronic product codes and bitmap values representing sets of electronic product codes;

FIG. 9 shows an aggregation event message that includes an ePC bitmap value and a database table that includes ePC bitmap values; and

FIG. 10 shows rowids in the database management system of the preferred embodiment and bitmap values representing sets of rowids

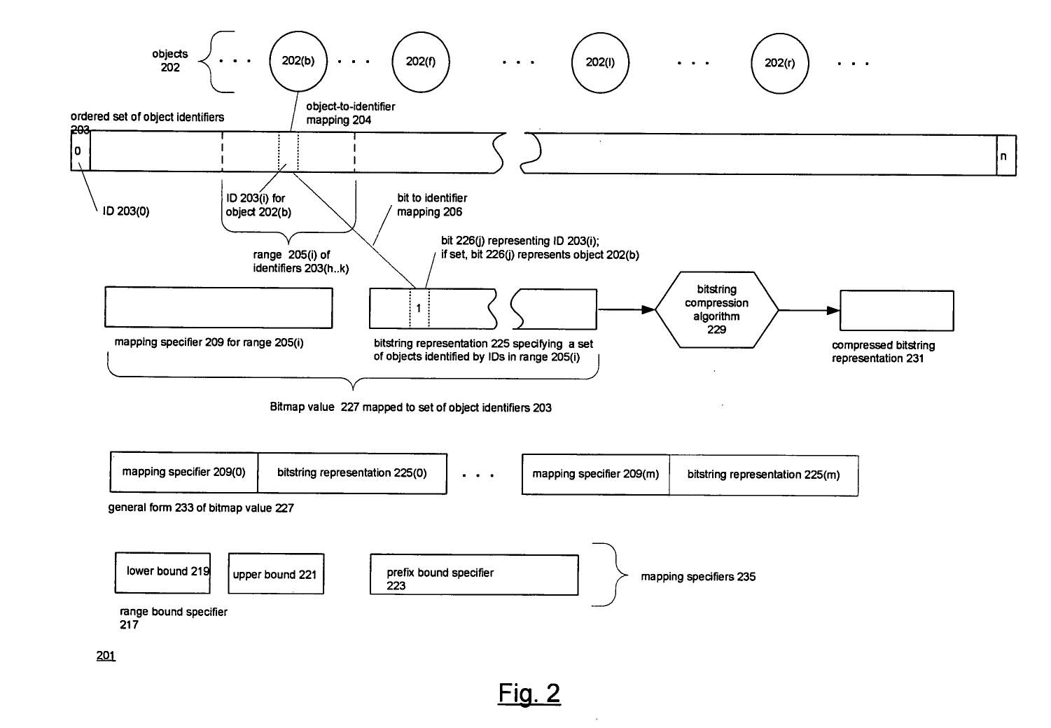

Reference numbers in the drawing have three or more digits: the two right-hand digits are reference numbers in the drawing indicated by the remaining digits. Thus, an item with the reference number 203 first appears as item 203 in FIG. 2.

### DETAILED DESCRIPTION

The following Detailed Description will first present an overview of an index made using bitmap values representing sets of rowids, will then present a general overview of how bitmap values may be defined in a database management system and of the operations that may be provided for them and will finally present two different species of bitmap values, one in which the bitmap values are mapped onto sets of rowids and another in which the bitmap values are mapped onto sets of electronic product codes (ePCs). At present, product codes such as bar codes only identify kinds of products, for example, the brand and flavor of a tube of toothpaste. Each tube of toothpaste of that brand that has that flavor carries the barcode for its kind. The ePC on an individual product not only identifies the product's kind, but also uniquely identifies each individual product item. Thus, each tube of toothpaste would have its own ePC.

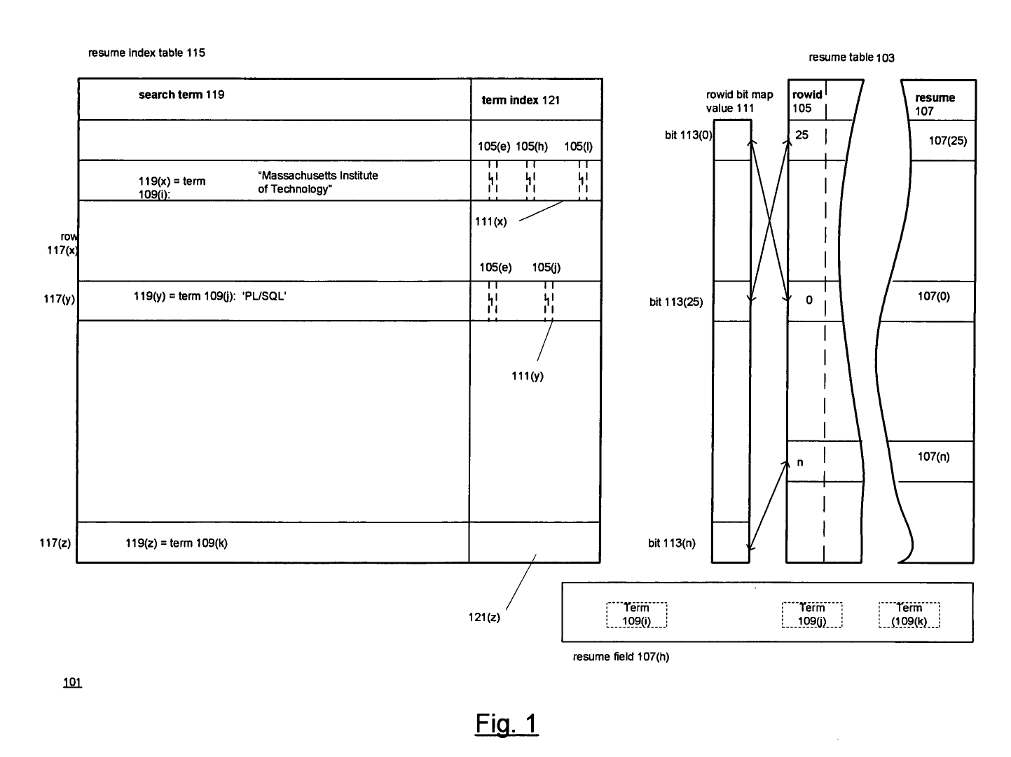

Overview of Bitmap Values: FIG. 1

FIG. 1 shows at 101 how rowid bitmap values 111 may be related to a set of rows in a first table 103 and how the bitmap values may be used in a second table 115 that serves as an index for information contained in the rows of the first table. In FIG. 1, table columns are identified by reference numbers and rows are identified by integers which represent the rows' rowids; a field in a row is identified by the reference number for the field's column and the integer for its rowid; thus the field belonging to rowid column 105 in the row having rowid 1 of table 103 is identified as field 105(1). What is contained in the field is of course a value of the type specified for the column to which the field belongs.

Beginning with table 103, table 103 is a table of resumes, each resume being a searchable electronic document. For purposes of the present discussion, resume table 103 has two columns, rowid column 105, which contains each row's rowid, and resume column 107, which contains a resume. As defined in Oracle 9i database management systems, a rowid is a value which uniquely identifies a row in a particular Oracle 9i database management system. In the present context, the rowid may be thought of as a large integer. There is a rowid for each row in a table in the Oracle 9i database management system, and thus every Oracle 9i table can be thought of as having a virtual column of rowids, whether or not the rowid column actually appears in the table's definition. The virtual nature of rowid column 105 is indicated by the dashed line used to define it in table 103.

A detail of a resume field 107(h) is shown below resume table 103. The resume field has the built-in type BINARY LARGE OBJECT, or BLOB, which means that the database management system treats the contents of the field simply as a collection of bytes. The only operations which the database management system can perform on fields of type BLOB are to read the bytes that the field currently contains or write a new collection of bytes to the field. It is up to the user of the database management system to properly interpret the contents of the BLOB. For example, if the contents of the BLOB were a .pdf file, the user could read the contents of the BLOB from the field and then use the Acrobat® software made by Adobe Systems, Incorporated to interpret or search the .pdf file. Contained in resume field 107(h) are a number of terms 109 that form the basis of indexes of the resumes. The terms might include items such as names of computer languages the person to whom the resume belongs is familiar with, degrees that the user has, or the educational institutions the person has attended. These terms may be located in the resume by a search utility that is part of the Acrobat software.

Since each resume is contained in a separate row of resume table 103 and is accessible via the row of table 103, the resumes may be indexed by specifying the row they belong to in resume table 103. Each row is of course identified by its rowid 105. As with the built-in bitmap indexes, a set of rowids may be specified by a bitmap value. Here, each rowid bitmap value 111 has a bit for each of the possible rowids in resume table 103 and the order of the bits representing the rowids in rowid bitmap values 111 corresponds to the numeric order of the rowids. The possible rowids in resume table 103 are those between the lowest rowid in the table and the highest rowid in the table. The rowids are not ordered by value in resume table 103 and there may be bits in the bitmap values 111 for which there are no corresponding rowids in table 103.

Resume index table 115 shows how an index to the terms 109 in the various resumes can be made using rowid bitmap values 111. Resume index table 115 is shown with two columns: a search term column 119 and a term index column 121. Each of the fields of search term column 119 contains one term for which an index of the resumes is desired. For example, if the resumes are to be indexed by computer language and educational institution, the terms might be “Massachusetts Institute of Technology”, “University of North Carolina”, “Worcester Polytechnic Institute,” and the like for the educational institutions and “C++”, “PL/SQL”, “Java”, and the like for programming languages.

Term index column 121 contains rowid bitmap values 111. Each of the values thus has a bit for each of the rows of resume table 103. The settings of the bits in a term index value 121(i) in row 117(i) show which of the resumes contain a term 109 which has the value specified in search term 119(i) of the row. For example, in row 117(x), the search term is “Massachusetts Institute of Technology”. Three bits of term index value 121(x) are set: those corresponding to rowids 105(e), 105(h), and 105(l), indicating that the resumes 107(e), (h), and (l) in those rows contain the search term “Massachusetts Institute of Technology”. Similarly, the search term 119(y) is “PL/SQL” and term index value 121(y) indicates that resumes 107(e) and (j) contain that search term. If a user were looking for someone with an MIT degree who knew PL/SQL, he or she could find that person by using the database management system to do the following:
1. get the bitmap values 121 from the rows in resume index table 115 which have “Massachusetts Institute of Technology” or “PL/SQL” as their search term values 119;
2. AND the returned bitmap values to get a result bitmap value in which the only bits that are set are for resumes that contain both search terms;
3. determine the rowids whose bits are set in the result bitmap; and
4. fetch the resumes 107 in the rows specified by the rowids.

It should be noted here that the only thing that can be determined from the bitmap value for a search term is whether the row with the rowid corresponding to a set bit in the bitmap value has the search term. The fact that a bit is not set can mean either that there is no row in the table corresponding to the bit's rowid or that the resume in the row does not have the search term.

As may be seen from the foregoing, the indexing arrangement shown at 101 permits the user to map bitmap values to a set of objects, to define the conditions under which a member of the set will cause the bit corresponding to the member to be set in a bitmap value, and to perform whatever bitmap operations are required on the bitmap values. Because the user can define the mapping between the bitmap value and the set of objects it represents and can define the conditions under which an object is a member of the set specified by the bitmap value, there is no longer any requirement that the values upon which bitmap indexes are based have a low cardinality. This permits bitmap indexes to be used in applications which index the occurrence of large sets of distinct patterns. Examples of such patterns are tokens in texts, biometric patterns, genome sequences, or OLAP cubes. There is also no longer any requirement that the values upon which the bitmap indexes are based are mutually exclusive. The indexing arrangement shown at 101 thus permits the use of membership conditions for the sets which specify overlapping ranges of values.

Overview of the Representation of Bitmap Values: FIG. 2

Of course, any arrangement which maps a set of objects to a bitstring can be used to define bitmap values. In a preferred embodiment, however, the arrangement is the following:
the objects are mapped to a very large set of ordered unique values. The set has a definition which is built into the database management system.
The bitmap values' bitstring is mapped to a range of the ordered unique values.

A bitmap value thus has two parts: a mapping specifier, which specifies the range of the ordered unique values, and a representation of the bitstring. The representation of the bitstring may be simply a bit string or it may be a bitstring which has been compressed using any of the techniques available for lossless compression of bitstrings.

FIG. 2 shows techniques 201 for representing bitmap values that in turn represent sets of objects. The objects are shown at 202. In order for the objects to be represented by bitmap values, they must be mapped onto an ordered set of unique object identifiers 203(0 . . . n). One such mapping 204 is shown: object 202(b) is mapped onto identifier 203(i). Because identifiers 203 are ordered and unique, a set of objects 202 that have been mapped onto identifiers 203 may be specified by specifying a range 205 of object identifiers 203 that includes the identifiers 203 to which the set of objects 202 have been mapped. A bitmap value 227 that specifies a subset of the objects 202 thus has two parts: mapping specifier 209, which specifies the range 205 of identifiers 203 that the bitmap is mapped to, and a bitstring representation 225. Bitstring representation 225 has a bit corresponding to each object identifier in range 205 and the bits are ordered in the same fashion as the object identifiers. Thus, there is a mapping 206 between each bit in bitstring 225 and an identifier 203 in range 205. Because of the mapping 204 and the mapping 206, bit 226(j) has been mapped to object 202(b). If object 202(b) is in the subset represented by bitmap value 227, bit 226(j) will be set. If bit 226(j) is not set, that may mean either that object 202(b) is not in the subset or that there is no object 202 mapped to bit 226(j). Bitstring representation 225 may be a simple bitstring or it may be compressed using any lossless bitstring compression algorithm to produce compressed bitstring 231.

Important attributes of bitmap values are their type, which is determined by the ordered set of object identifiers onto which the bitmap values are mapped, and their class, which is determined by the range(s) of object identifiers onto which the bitmap values are mapped. Thus, all bitmap values 227 which are mapped to the range 205(i) specified by mapping specifier 209 have the same class. In the preferred embodiment, there are two types of bitmap values: rowid bitmap values, which are mapped to the set of rowid values in the database management system containing the bitmap values, and ePC bitmap values, which are mapped to the set of values that make up the electronic product code. In a preferred embodiment, the type required for a bitmap value or operation is indicated in the definition of the bitmap value's field or of the operation being performed on the bitmap value. The class of the bitmap value in a preferred embodiment is implied by the bitmap value's mapping specifier 209. In other embodiments, the class required for a bitmap value may be indicated in the definition of the bitmap value's field. For example, the definition of the column to which the field belongs may require that the bitmap value be a rowid bitmap value for which the range of rowids is the range of rowids in a particular table. The type and class of a bitmap value can be used to determine whether an operation on a bitmap is legal and to perform conversions. For example, operations involving operands whose bitmap values have different types are not legal and in some embodiments, bitmap value operands for some operations may be required to have the same class. Where operands are not required to have the same class, performing an operation may require that the operands are converted into a common class.

Also shown in FIG. 2 are a general form 233 for a bitmap value 227 and two ways of representing ranges in a mapping specifier 209, shown at 235. The general form of a bitmap value 227 is a set of mapping specifier 209 and bitstring representation 225 pairs; more than one pair may be used either because it is required by a property of the ordered set of object identifiers 203 or because the mapping of objects 202 to identifiers is sparse, so that specifying a number of mapping specifier and bitstring representation pairs requires less storage space than specifying a single mapping specifier and a bitstring representation 225 large enough to include the whole range specified in the mapping specifier.

One way of specifying the bounds of the range in mapping specifier 209 is by specifying its lower bound 219 and its upper bound 221, as shown at 217. Another is by using a prefix bound specifier, as shown at 223. To give some examples, if the ordered set of objects includes 100 objects 0 . . . 99, objects 20-29 may be specified by the range specifier 20-29. Alternatively, the numbers 0 . . . 99 may be seen as each containing a prefix, namely the 10's digit, and a suffix, namely the 1's digit and the range 20-29 may be represented by the prefix 2, the range 0-9 by the prefix 0, and so on. Which is used will of course depend on the kinds of ranges desired. For example, in the rowids employed in the Oracle 9i database management system, the rowid's object number, file number, and block number could be used as a prefix for a range of rowids that would include all of the rowids belonging to the table specified by the object number.

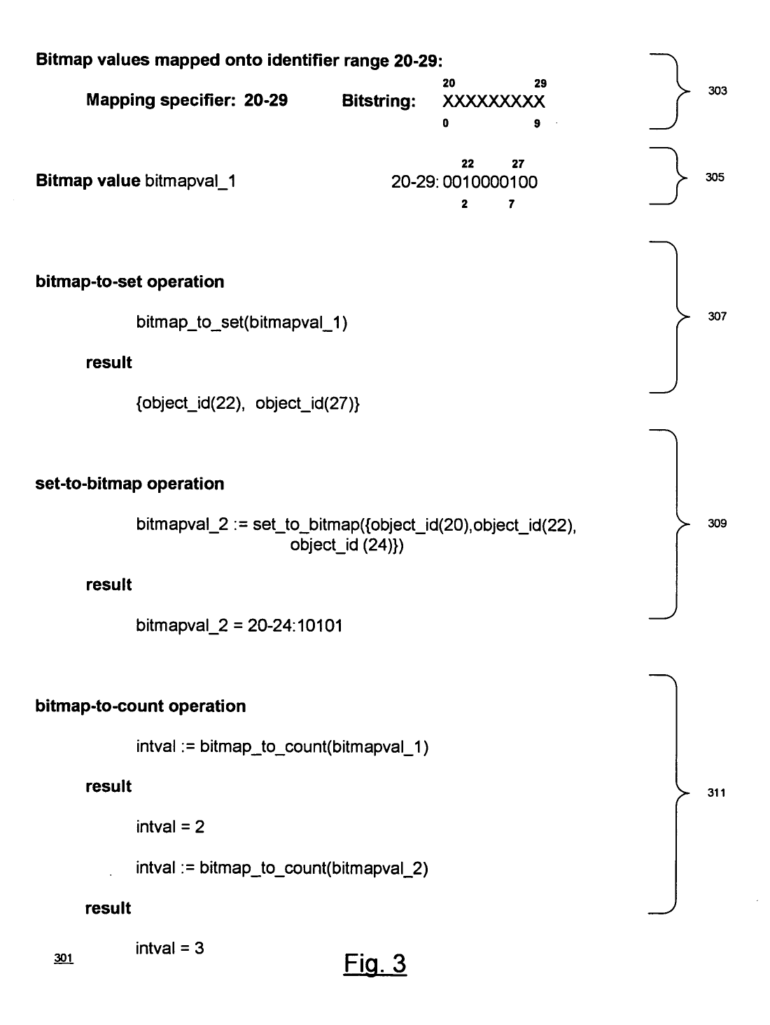

Overview of User-Accessible Bitmap Operations: FIGS. 3-6

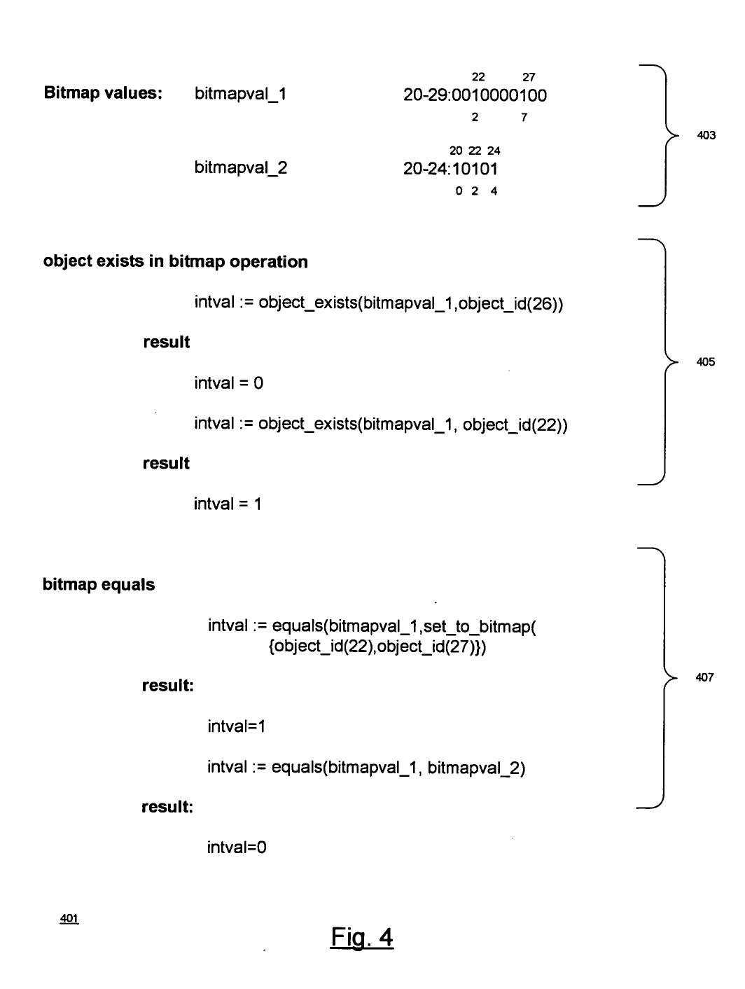

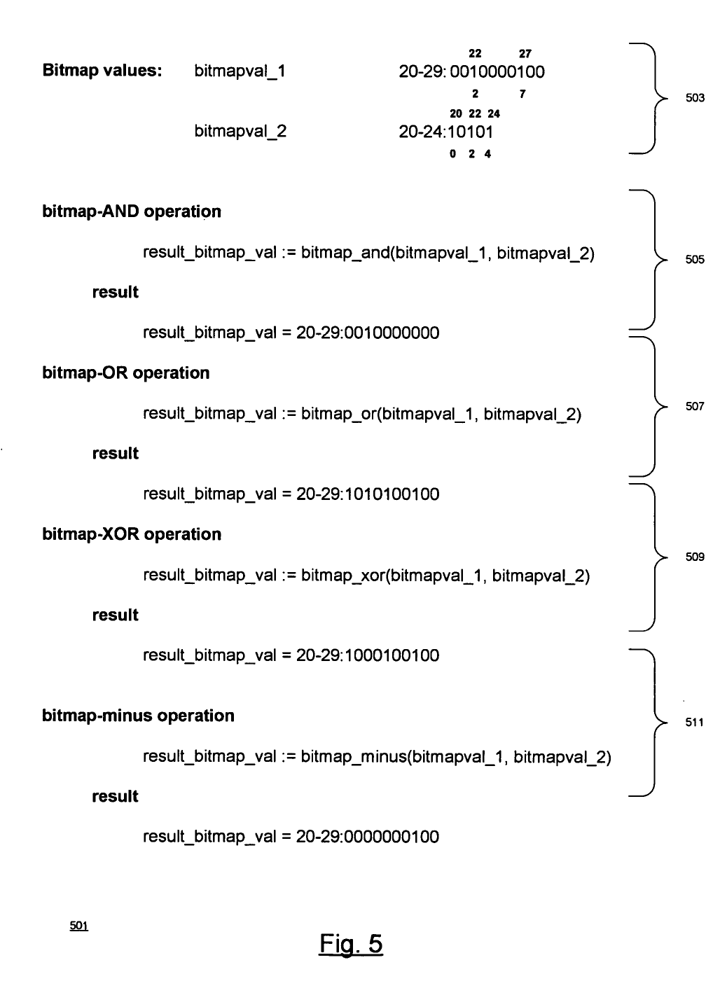

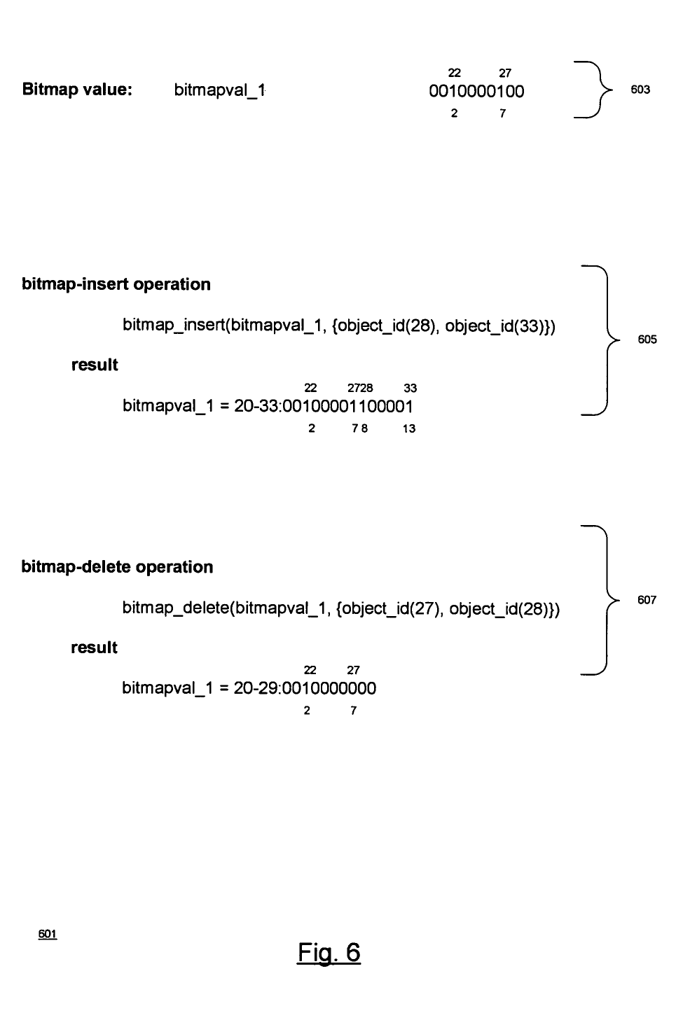

The user-accessible bitmap operations of the invention fall into four groups. The operations are shown in detail in FIGS. 3-6. For details of the semantics of the operations, see the descriptions of the figures.
1. conversion operations that convert to and from bitmap values: FIG. 3
   a. bitmap to set: converts a bitmap value to the set of object identifiers specified by the set bits in the bitmap value's bitstring;
   b. set to bitmap: converts a set of the object identifiers to the bitmap value that represents the set;
   c. bitmap to count: converts a bitmap value to a count of the number of set bits in the bitmap and hence to the number of objects in the object set represented by the bitmap.
2. the existence operation: determines whether the set of object identifiers represented by a bitmap value includes the object identifier for a particular object: FIG. 4
3. logical operations on bitmap values: FIG. 5
   a. bitmap AND: ANDs two bitmap values that have the same class;
   b. bitmap OR: ORs two bitmap values that have the same class;
   c. bitmap XOR: XORs two bitmap values that have the same class; and
   d. bitmap MINUS: removes object identifiers in the set specified by one bitmap value of a class that are also in the set specified by another bitmap value of the same class from the one bitmap value.
4. Changing the set of object identifiers represented by a bitmap value: FIG. 6
   a. bitmap insert: takes a set of object identifiers and a bitmap value and if any of the set is not included in the range specified for the bitmap value's class, expands the range and creates a new bitmap value for the expanded range in which both the bits that were formerly set and the bits corresponding to the object identifiers in the set are set.
   b. bitmap delete: takes a set of object identifiers and a bitmap value and if any of the set is included in the range specified for the bitmap value's class, setting the bit for the object identifier in the bitmap value to 0.
5. Bitmap comparison: the bitmap EQUALS operation compares two bitmap values and determines whether the two values represent the same set of object identifiers. See FIG. 4
6. Bitmap assignment: assigns a source bitmap value to a target variable that represents a bitmap value of the same type as the source value. See FIG. 3
   The Conversion Operations: FIG. 3

FIG. 3 provides examples of conversion operations 301 and of a bitmap assignment. A class of bitmap values that will be used in the following examples of the operations is shown at 303. The bitmap values of the class have a mapping specifier that specifies range 20-29 of object identifiers 203 and a ten-bit bitstring whose bits 0 . . . 9 have been mapped onto object identifiers 20 . . . 29. In the following discussion, the bitmap values will be represented by the notation <lower_bound-upper_bound>:<bitstring>. Thus, as shown at 305, bitmapval_1, which represents the set of objects corresponding to the identifiers 22 and 27, has bits 2 and 7 set and is represented by the notation 20-29:0010000100.

In bitmap-to-set operation 307, the bitmap_to_set operator takes a single operand, namely a bitmap value, in this case, the bitmap value bitmapval_1, and returns the identifiers specified by the set bits in the bitstring, in this case identifier(22) and identifier(27).

In set-to-bitmap operation 309, the set_to_bitmap operator takes a set of object identifiers, here the set made up of identifier(20), identifier(23), and identifier(24), and returns a bitmap value bitmapval_2 whose mapping specifier specifies the range 20-24 and has a 5-bit bitstring in which bits (0), (3), and (4) corresponding to those object identifiers have been set, giving the bitmap value 20-24:10101. That bitmap value has been assigned to the variable bitmapval_2. The variable must have the type of the source bitmap value being assigned to it and will have the source bitmap value's class and value after the assignment.

In bitmap-to-count operation 311, the bitmap_to_count operator takes a bitmap value of any class and returns the number of bits that are set in the bitmap, i.e., the number of object identifiers in the set represented by the bitmap. Two examples are given: bitmap_to_count (bitmapval_1) returns 2 because that many bits are set in the bitmap value; bitmap_to_count (bitmapval_2) returns 3 because that many bits are set in that bitmap value.

The Existence Operation and the Equals Operation: FIG. 4

The existence operation takes a bitmap value and an object identifier of the kind corresponding to the bitmap value's type and returns 1 if the bit corresponding to the object identifier is set in the bitmap value and 0 if it is not. 0 thus indicates either that the object identifier is in the bitmap value's range but its bit is not set or that the object identifier is not in the bitmap value's range. In FIG. 4, the bitmap value is bitmapval_1, in which the bits representing object identifiers 22 and 27 are set. As shown at 405, when the object_exists operator has identifier(26) as its object identifier argument, it returns 0, since object identifier(26)'s bit is not set in bitmapval_1. When the operator has identifier(22) as its object argument, it returns 1, since identifier(22)'s bit is set in bitmapval_1.

The equals operation takes two bitmap values that belong to the same type and returns 1 if the two bitmap values represent the same set of object identifiers and otherwise 0. As shown at 407, the operation returns 1 when bitmapval_1 is compared with the result of a set_to_bitmap operation that returns a bitmap with bits set for object_id(22) and object_id(27) and 0 when bitmapval_1 is compared with bitmapval_2. In this operation, both bitmap values are converted to the same class before the comparison is made.

Logical Operations on Bitmap Values: FIG. 5

These operations are like the logical operations performed on bitstrings. The operations all have two bitmap operands belonging to the same class. In a preferred embodiment, if both bitmap values have the same type, one or both of the operands are converted to a class whose range includes both operands. If the bitmap values have different types, an error results. The operations and their results are shown at 501 in FIG. 5. The operands are bitmap values bitmapval_1 and bitmapval_2, whose values are shown at 503. At the beginning of each of these operations, bitmapval_2 is converted to the class of bitmapval_1. The bitmap-AND operation is the standard logical AND operation, as shown at 505; the bitmap-OR operation is the standard logical OR operation, as shown at 507; and the bitmap-XOR operation is the standard logical XOR operation, as shown at 509. The bitmap-XOR operation returns a bitstring containing all 0's when the two operands are identical and therefore can be used to implement the bitmap equals operation. The bitmap-minus operation makes a result bit string in which bits are set as in the first operand except where the same bits is set in both the first and second operands, in which case the corresponding bit in the result is reset. It is equivalent to the logical operation bitmapval_1 AND (NOT bitmapval_2). The operation is shown at 511.

Changing the Set of Object Identifiers Represented by a Bitmap Value: FIG. 6

When the set of object identifiers represented by a bitmap value changes, the bitmap value must also change. The change may only involve setting and/or resetting bits already contained in the bitmap value's bitstring, but it may also involve changing the mapping specifier and the length of the bitstring. The operations for changing the set of object identifiers represented by the bitmap value are the bitmap insert operation, which adds object identifiers to the set, and the bitmap delete operation, which deletes object identifiers from the set. With both operations, the operands are the bitmap value to be changed and a set of object identifiers to be added to or deleted from the bitmap value.

The bitmap insert and delete operations are shown at 601 in FIG. 6. The bitmap value operand is bitmapval_1, shown at 603. The bitmap insert operation is shown at 605. The second operand is the set of object identifiers {object_id (28), object_id (29)}. Neither of these objects is already included in the set represented by bitmapval_1; the second object is furthermore outside bitmapval_1's current range. Consequently, the bitmap insert operation extends bitmapval_1's range so that it can include both new objects. The new value of bitmapval_1 is thus 20-33:00100001100001, whose bitstring representation represents 14 bits and in which the bits are set that represent object identifiers 22, 27, 28, and 33.

The bitmap delete operation is shown at 607. Here, the second operand is the set of objects {object_id (27),object_id (28)}. Both of these object identifiers are within the range of bitmapval_1, but only object identifier 27 is in the set of object identifiers represented by bitmapval_1, so the result of the operation is a new value of bitmapval_1 in which bit 7 corresponding to object_id (27) has been reset. As already explained, some bitmap values may be represented as a set of mapping specifier and bitmap pairs; when that is the case and the bitmap delete operation deletes all of the objects in a subrange, the mapping specifier and bitmap pair for the subrange may be removed from the set of mapping specifier and bitmap pairs.

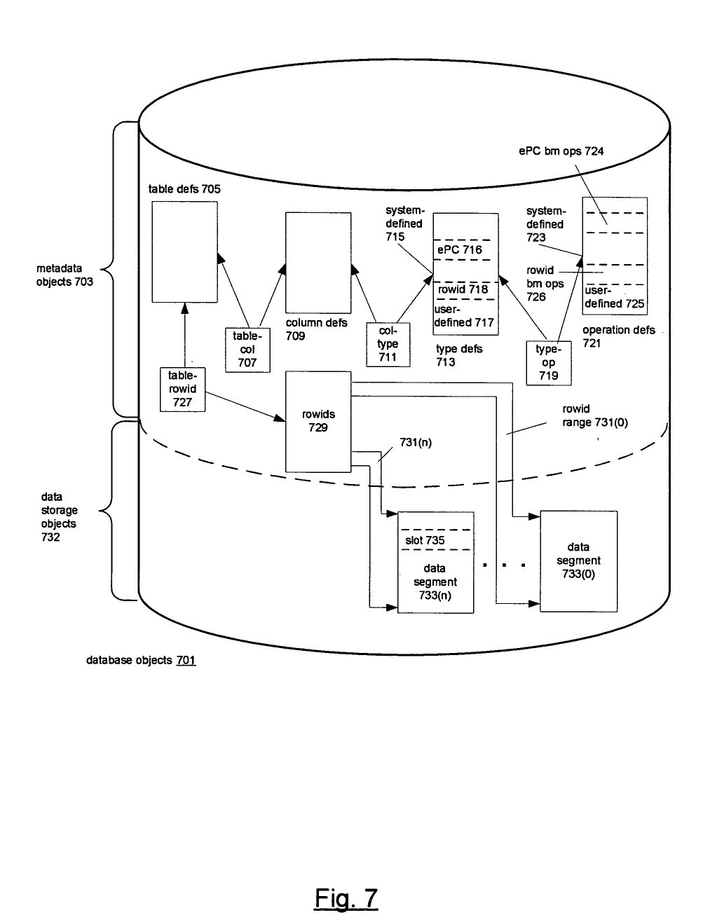

A Database Management System with Bitmap Datatypes: FIG. 7

FIG. 7 is a conceptual overview of database objects 701 belonging to a database management system that implements two bitmap datatypes: a rowid bitmap data type in which the set of object identifiers to which the bitmap values are mapped is the set of rowids in the database management system, and an ePC bitmap data type in which the set of object identifiers is a set of electronic product codes. Database objects 701 fall into two classes: metadata objects that define all of the objects in the database management system, including the metadata objects themselves, and data storage objects 732, in which the data making up the objects is stored. Data storage objects 732 are contained in persistent storage such as a file system.

Continuing with metadata objects 703, table definitions 705 is a table whose entries are definitions of the tables in the database management system. There is an entry in this table for each of the tables. Column definitions 709 is a table whose entries are definitions of the columns used in the tables. Type definitions 713 is a table whose entries are definitions of the data types specified for the columns. In the database management system of the invention, type definitions 713 include system-defined types 715 and user-defined types 717. Included in the system-defined types are rowid bitmap type 718 and ePC bitmap type 716. Associated with each type, whether user-defined or system defined, is a set of operations. These are defined in operation definitions table 721. Included in table 721 are definitions of user-defined operations 725 and definitions of system-defined operations 723. Among the system-defined operations are operations 726 for rowid bitmap values and operations 724 for ePC bitmap values. User-defined operations may employ code contained in the database management system or code external to the database management system. Rowid table 729, finally, is a table of the rowids for all of the rows currently in the database management system. The rowids are arranged in sequential order, with each data segment 733(i) defining a range of rowids 731(i). Each rowid points to a slot 735 in a data segment 733 that actually contains the data for the row indicated by the rowid. Large tables may have data in more than one data segment 733.

The tables defined in table definitions 705 are related to rowids for the table's rows by table-rowid relation table 727 and to column definitions 709 for the table's columns by table-column relation table 707. Column definitions are related to type definitions by column-type relation table 711 and type definitions are related to operation definitions by type-operation definition table 719. These relation tables make it possible to determine what columns and rows belong to a table defined in table defs 705, what types the columns have, and what operations the types have.

The Rowid Bitmap Data Type

In the rowid bitmap data type, the database management system's rowids make up ordered set of object identifiers 203. The objects 202 which may be mapped to the rowids are any objects contained in the database rows represented by the rowids. In a rowid bitmap value, mapping specifier 209 maps the bitstring 225 onto a range of rowids. Each bit of the bitstring represents one of the rowids in the range. When a bit is set in bitstring 225, the set bit represents the presence of a particular value in one or more of the fields in the row whose rowid corresponds to the set bit in the bitstring. The following discussion will begin with details of rowids in a preferred embodiment and of the representation of sets of rowids employed in a preferred embodiment, will then summarize operations on rowid bitmap values, and will finally disclose an implementation of resume table 103 and resume index table 115 using rowid bitmap values.

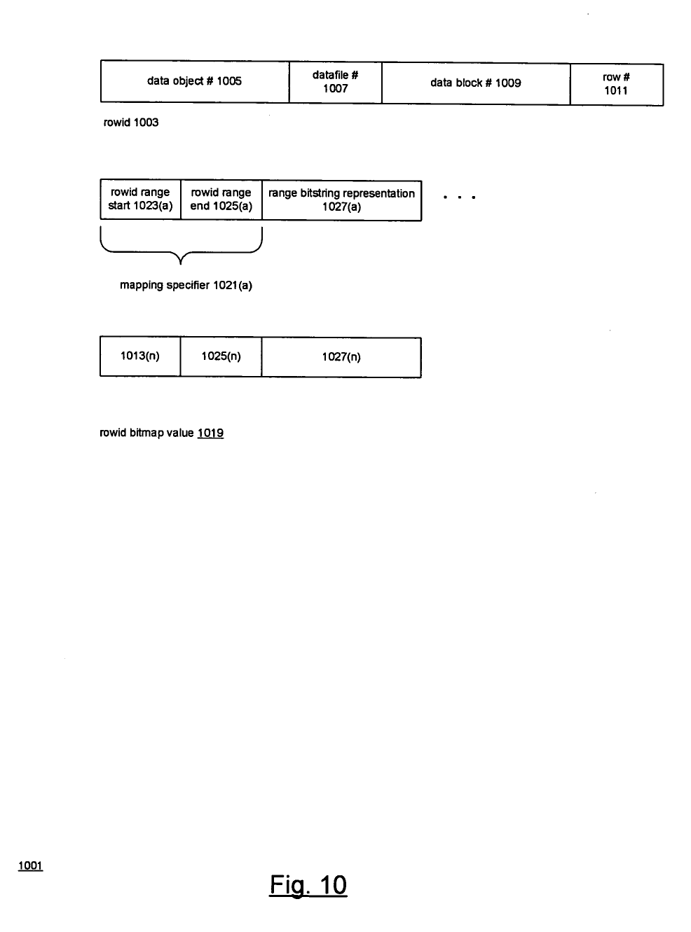

Details of the Rowid Bitmap Data Type: FIG. 10

Form of Rowids

In the Oracle 9i database management system, rowids use a base 64 encoding of the physical address for the row specified by the rowid. The encoding characters are A-Z, a-z, 0-9, +, and /. An extended rowid has a four-piece format, OOOOOOFFFBBBBBBRRR:
OOOOOO: The data object number that identifies the database segment. Schema objects in the same segment, such as a cluster of tables, have the same data object number.
FFF: The tablespace-relative datafile number of the datafile that contains the row.
BBBBBB: The data block that contains the row. Block numbers are relative to their datafile, not tablespace. Therefore, two rows with identical block numbers could reside in two different datafiles of the same tablespace.
RRR: The offset for the storage for the row in the block.

FIG. 10 shows a rowid 1003, with data object number 1005, data file number 1007, data block number 1009, and row offset 1011.

Rowid Bitmap Values

The general form of a rowid bitmap value 1019 is shown at 1019 in FIG. 10. Rowid bitmap values are made up of a sequence of one or more mapping specifiers 1021 and bitstring representations 1027. In a rowid bitmap value, the mapping specifier specifies ranges of rowids by specifying a rowid range start value 1023 and a rowid range end value 1025. There is a range bitstring representation 1027 corresponding to each mapping specifier, and the bitstring has a bit for each of the rowids in the range specified by the mapping specifier.

One situation in which more than one mapping specifier 1021 and range bitstring 1027 is employed is when the range of rowids to which the bitstring is being mapped includes rowids specifying locations in more than one data segment 733. When the mapping specifier maps the bitmap to rowids that are contained in more than one data segment 703, the bitmap value takes the form <mapping specifier for the range(i) of rowids in segment a>:<bitmap representation for range (i)>, <mapping specifier for the range (j) of rowids in segment b>:<bitmap representation for subrange (j)> . . . and so on for all of the subranges that are necessary to map the bitmap value onto the rowids. This technique can of course be used in any case where a bitmap value may represent objects whose values do not form a continuous sequence. It can also be used when the objects of interest are sparsely dispersed across the range of objects. In such a situation, a collection of mapping specifiers for subranges of interest, each with its own bitstring representation, may require less storage space than a single mapping specifier and very large bitstring specification for the entire range over which the objects are dispersed.

Specifying a Column of Rowid Bitmap Values in a Table

The DDL for specifying resume index table 115 looks like this:
CREATE TABLE ResumeIndexTable
(SearchTerm CHAR(30),
TermIndex ROWIDBITMAP);

In a preferred embodiment, the fields of the column TermIndex must contain rowid bitmap values but may contain rowid bitmap values of any class. In other embodiments, the DDL may specify a table to which the rowids that are mapped to the bitmap values belong, and in that case, the bitmap values in the column can be constrained by the database management system to belong to the class of bitmap values that are mapped to the table's rowids.

Operations on Rowid Bitmap Values

The following operations are defined for rowid bitmap values in operation definitions 721:
1) Conversion operations
   a) BITMAP2ROWIDS: This function converts a rowid bitmap value to the corresponding set of rowids.
   b) BITMAP2COUNT: This function converts a rowid bitmap value to the corresponding count of rows for which bits are set in the rowid bitmap value
   c) ROWIDS2BMAP: This function converts a set of row identifiers to a rowid bitmap value.
2) The existence operation: ROWIDEXISTS: This function determines whether a rowid belongs to the set of rowids represented by a rowid bitmap value.
3) Logical operations:
   a) BITMAP_AND: This function takes two rowid bitmap values and returns a rowid bitmap value which is the AND of the two operands;
   b) BITMAP_OR: This function takes two rowid bitmap values and returns a rowid bitmap value which is the OR of the two values.
   c) BITMAP_XOR: This function takes two rowid bitmap values and returns a rowid bitmap value which is the XOR of the two values.
   d) BITMAP_MINUS: This function returns the result of the first rowid bitmap argument MINUS the second rowid bitmap argument.
4) Changing the set of rowids represented by a rowid bitmap value:
   a) BITMAP_INSERT: This function takes a rowid bitmap value and set of rowids as arguments and sets the bits in the rowid bitmap value corresponding to the rowids in the set.
   b) BITMAP_DELETE: This operation takes a rowid bitmap value and a set of rowids as arguments and resets the bits in the rowid bitmap value corresponding to the rowids in the set.
5) BITMAP_EQUALS: this operation takes two rowid bitmap values as arguments and returns a value that represents TRUE if the bitmap values represent the same set of rowids and otherwise returns a value that represents FALSE. The values may be converted to the same class before the operation is performed.
6) assignment: this operation assigns a source rowid bitmap value to a rowid bitmap target variable such as a field in a table. At the end of the operation, the target variable has the source value's class and value.

The operations on rowid bitmap value work as described in the general discussion of bitmap operations. In a preferred embodiment, the class of the result bitmap in the ROWIDS2BMAP, BITMAP_INSERT, and BITMAP_DELETE operations is determined from the rowids contained in the result bitmap. With the logical operations, the operands are converted to bitmap values of a class which includes all of the rowids specified in the operand bitmap values. In assignments of bitmap values, the target bitmap acquires the class and value of the source bitmap value. Other embodiments may require that the source and target bitmap values have the same class in the assignment operation or that the operands in the logical operations have the same class.

Implementing Resume Table 103 and Resume Index Table 115 with Rowid Bitmap Values

ResumeTable 103

ResumeTable 103 has a column, Resume 107, whose values are objects of a user-defined class resume. The user-defined operation which is of interest for this class is a contains operation that takes a character string and a resume object as operands. The operation uses the Acrobat search operation to determine whether a resume contains a particular character string. The existence of this operation makes it possible to query resume table 103 for resumes containing a particular character string.

ResumeIndexTable 115

ResumeIndexTable 115 has a column, TermIndex 121, whose values are rowid bitmap values representing sets of the rowids for the rows in ResumeTable 103 and a column SearchTerm 119 whose values are terms that are of interest in the resumes of table 103. The set of the rowids of ResumeTable 103 represented by the value of TermIndex in a particular row of ResumeIndexTable 115 is made up of the rowids from ResumeTable 103 for the rows in which the resume in the resume field contain the value of SearchTerm 119 in the particular row of ResumeIndexTable 115.

Setting the Bitmap Values in ResumeIndexTable 115

A query on resume table 103 that uses values from search term column 119 in resume index table 115 can be used to set bitmap values in term index column 121. One version of the query would look like this:

```
UPDATE ResumeIndexTable
      SET TermIndex := ROWIDS2BITMAP( TO_SET(
            SELECT rowid FROM ResumeTable
            WHERE contains (Resume, “Massachusetts
                  Institute of Technology”)))
      WHERE SearchTerm = “Massachusetts Institute of
              Technology”;
```

This query sets TermIndex in each row of ResumeIndexTable to the bitmap value corresponding to the rowids for the rows in ResumeTable whose Resume fields contain resumes with the search term specified by SearchTerm. The rowids are found by a SELECT query that uses the user-defined contains function, and the result of the query is converted to a set of rowids by the TO SET operation and the set of rowids is converted to a bitmap value by ROWIDS2BITMAP.

Using the Bitmap Values to Locate Resumes in ResumeTable 103

A query that produced those resumes from ResumeTable 113 in which both the terms “Massachusetts Institute of Technology” and “PL/SQL” appeared might look like this:

```
SELECT resume FROM ResumeTable
WHERE rowid IN BITMAP2ROWIDS(BITMAP_AND(
(SELECT TermIndex FROM ResumeIndexTable WHERE
      SearchTerm = “Massachusetts Institute of
      Technology”),
  (SELECT TermIndex FROM ResumeIndexTable WHERE
      SearchTerm = “PL/SQL”)));
```

In this query, the resumes are selected from ResumeTable on the basis of the rowids which the bitmap values in Resume IndexTable show have resumes which contain both of the search terms “Massachusetts Institute of Technology” and “PL/SQL”. Starting at the bottom of the query, the TermIndex bitmap values are selected using the two search terms; these bitmap values are then the operands of the BITMAP_AND operation; the bitmap value that results form the BITMAP_AND operation contains set bits for the rowids for every row in ResumeTable whose Resume field contains both of the search terms. The result bitmap value is then used as an operand in the BITMAP2ROWIDS operation, which produces the set of rowids specified in the result bitmap value, and these in turn are used to select the resume fields containing the desired resumes.

Maintaining the Bitmap Values in TermIndex Column 121

Whenever a row in ResumeTable 103 is updated or a row is added to or deleted from table 103, the bitmap values in TermIndex row 121 must be recomputed so that they reflect the current state of the resumes in ResumeTable 103. In the relational database management system of the preferred embodiment, such recomputation is done by means of one or more trigger programs that have been written for ResumeTable 103 and are executed whenever a row is modified in ResumeTable 103, deleted from the table, or added to it.

One way of doing the recomputation would be to have the trigger execute the query disclosed above that is used to compute all of the bitmap values in TermIndex column 121. However, this approach requires that every resume in the table is searched, and as ResumeTable 103 grows in size, the overhead of this approach grows as well. The overhead can be reduced by using the BITMAP_INSERT operation, which requires only that the resumes in the added rows be searched and the BITMAP_DELETE operation, which simply resets the bit in a rowid bitmap which corresponds to a deleted row. When a row of ResumeTable 103 is updated, it is treated as a deletion of a row followed by an insertion of a new row. Code for a trigger on ResumeIndexTable 115 that updated the values in TermIndex column 121 when a row was added to ResumeIndexTable 115 might look like this:

AFTER INSERT OF Resume ON ResumeTable FOR EACH ROW

| | | |
|---|---|---|
| DECLARE | BitmapIn | ROWIDBITMAP; |
| | BitmapOut | ROWIDBITMAP; |

```
BEGIN
    FOR Each Search_Term IN new:Resume
      SELECT TermIndex INTO BitmapIn FROM ResumeIndexTable
```

WHERE contains(new:Resume, Search_Term);

IF BitmapIn is NOT NULL

```
ROWID_BITMAP_INSERT (BitmapIn,
      TO_SET(new:RowID), BitmapOut);
UPDATE ResumeIndexTable SET TermIndex =
      BitmapOut WHERE
      ResumeIndexTable.SearchTerm = Search_Term;
```

ELSE

```
INSERT INTO ResumeIndexTable VALUES
      (Search_Term, ROWIDS2BMAP
      (TO_SET(new:RowID)));
```

```
      END IF;
    END LOOP;
END;
```

The code in the trigger is executed on each row of ResumeIndexTable 115 whenever a row is added to ResumeTable 103. The two bitmap variables are used for bitmap values within the trigger. The SELECT statement determines whether the value of the field SearchTerm in the row is found in the field Resume in the new row of ResumeTable 115. If it is found, the bitmap in the field TermIndex for the row of ResumeIndexTable 115 is copied to the bitmap variable BitmapIn.

ROWID_BITMAP_INSERT is then used to modify the bitmap value in BitmapIn as required for the relevant new row of ResumeTable. The modified bitmap value is in BitmapOut. If a bit corresponding to the rowid is already in the rowid value in BitmapIn, it is set in BitmapOut; if there is no bit corresponding to the rowid in BitmapIn, BitmapOut's mapping specifier is modified to include the rowid, a bitmap is made that corresponds to the mapping specifier, and the bits that were set in BitmapIn, as well as the bit for the new rowid, are set in BitmapOut. The UPDATE statement is then used to set the TermIndex bitmap value in the relevant row of ResumeIndexTable 115 to the bitmap value contained in BitmapOut.

Other Applications of Rowid Bitmap Values

Every row in a relational database management system has a rowid and any query can return the rowids of the rows which satisfy the query; consequently, rowid bitmap values can be used to represent subsets of any set of objects in the database management system for which a query may be defined. Since a row may contain many objects, the specific set of objects which is represented by a given rowid bitmap value depends on the query which was used to obtain the rowids.

A consequence of the fact that rowid bitmap values can be used to represent subsets of any set of objects for which a query may be defined is that bitmap indexes may be made using the techniques shown with regard to FIG. 1 for any set of objects which satisfies the following conditions:
objects belonging to the set can be represented one or more columns of a database table; and
the objects in the set have one or more queryable attributes.

What is required for the index is one or more primary tables with columns whose values represent the objects being indexed and an index table which contains at least a column whose values are queryable attributes of the objects being indexed and a column whose values are rowid bitmap values. In each row of the index table, the row's bitmap value shows which of the objects being indexed in the primary table have the value of the queryable attribute specified in the row of the index table. About the only limitation on what can be indexed using bitmaps of rowids is that each object being indexed requires its own row in a table in the database management system. Where the number of objects being indexed is truly large, the required number of rows may be beyond the capacity of the database management system.

A consequence of the fact that any queryable attribute may determine whether a bit is set in a bitmap is that the bitmap may be set according to any property of an attribute. For example, if greater than and less than operations may be performed on the attribute values, queries may be based on ranges of the attribute values and because each range of the attribute values may correspond to a different bitmap value, the ranges of the attribute values may overlap. To give a simple example, if the object being indexed has a temperature attribute, there may be bitmap values for the Fahrenheit ranges 32-98.6 and 32-212.

At the most fundamental level, rowid bitmap values are persistent representations of sets of rows in a database management system. Further, since every query returns a set of rowids, any query may be persistently represented by a rowid bitmap value specifying the returned set of rowids. For example,

```
BitmapValue:= ROWIDS2BITMAP ( TO_SET(
      SELECT rowid FROM ResumeTable
      WHERE (contains (
      ResumeTable.Resume,
      ResumeIndexTable.SearchTerm
      ))));
```

sets the bitmap variable BitmapValue to the bitmap for the rowids returned by the SELECT statement. As long as the rowids in ResumeTable do not change, BitmapValue can be used to retrieve the rows specified by the query from which BitmapValue was set.
The ePC Bitmap Data Type

An example of a set of objects that is too large to be represented by making a table in which each object has a row is the set of objects that are identified by ePCs. For that reason, a preferred embodiment of the database management system of FIG. 7 includes a built-in EPC bitmap data type 716 and system-defined ePC bitmap operations 724. The following discussion will first describe ePCs in detail, will then describe bitmap values that are mapped to ePCs and therefore have the ePC bitmap data type, the operations for the ePC bitmap data type, and finally examples of the use of ePC bitmap values.

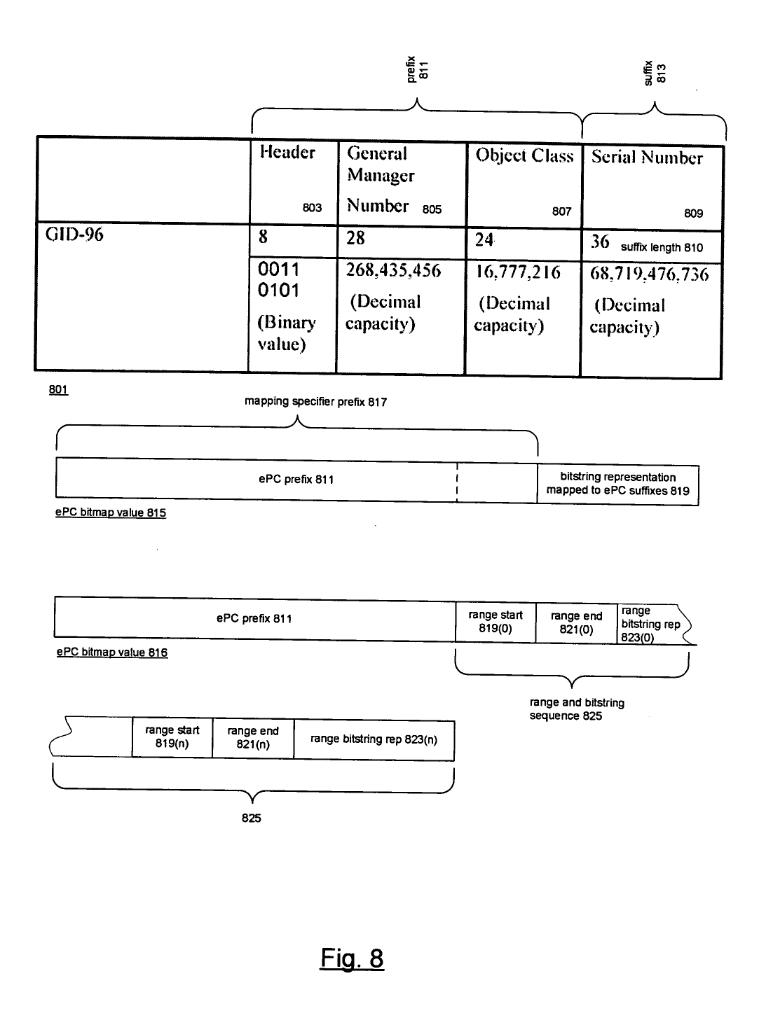

ePCs: FIG. 8

An electronic product code or ePC, is a standard product code which uniquely identifies an individual product item. The standard for ePCs is still under development. As set forth in EPC™ Tag Data Standards Version 1.1 Rev.1.23, Last Call Working Draft on 16 February 2004, copyright 2003, EPC Global, which is hereby incorporated by reference, an ePC may have 64 or 96 bits. The general form of the 96-bit ePC is shown at 801 of FIG. 8. The 96-bit value is divided into four fields: an 8-bit header field 803, which defines the sizes of the following fields and how they are to be interpreted, a general manager field 805, which identifies an entity such as a manufacturer who manages a set of ePC codes, an object class field 807, which identifies a class of objects, for example, a product made by the manufacturer identified in field 805, and a serial number field 809 which identifies individual items of the product specified by object class identifier 807. An ePC value is often divided into two parts: the prefix 811, made up of fields 803-807, and the suffix 813, made up of serial number field 809. The length of the suffix may be determined by information in header 803. As can be seen by the decimal capacities indicated by fields 805, 807, and 809, the 96-bit ePC can identify astronomical numbers of objects. The 64-bit ePC is smaller, but has the same overall form as the 96-bit ePC. In the preferred embodiment, there are two types of bitmap values representing sets of ePCs. Bitmap values representing sets of 96-bit ePCs belong to one of the types and those representing sets of 64-bit ePCs belong to the other. The following discussion of ePC bitmap values applies to ePC bitmap values of both types.

ePC Bitmap Values

The problem which ePC values present for database management systems that are managing inventory is that each product item now has a 96-bit (or 64-bit) unique identifier. If the usual database management system techniques for representing objects are used, product items will be identified by fields in tables, with each product item having a row in the table and each row requiring a field for the product item's ePC. Further, messages indicating what product items are in an inventory will also require an ePC for each product item. The amount of space that is required within a database management system or within a message indicating that a product item is in an inventory can be greatly reduced if a set of product items is represented by a bitmap value whose mapping specifier maps the value's bitmap onto a set of the ePCs. If the product item to which a specific ePC belongs is present in a group of product items, then the bit corresponding to the ePC is set in the bitmap value. The bitmap value can thus replace a list of as many ePCs as there are bits in the bitmap value.

Ways of implementing ePC bitmap values are shown at 815 and 816. The simplest form 815 of an ePC bitmap value uses ePC prefix 811 by itself as the mapping specifier 817 and bitstring 819 represents all of the suffixes that may have the prefix. When an item having the suffix is present in the set of ePCs represented in the bitmap value, the item's bit in the bitmap value is set. In many cases, the serial numbers in a set of ePCs of interest all have the same most significant bits. In this case, mapping specifier 817 can be extended beyond ePC prefix 811 to include the same most significant bits. The bit string then represents the set of all serial numbers having the same prefix 811 and the same most significant bits.

Form 816 of an ePC bitmap value uses ePC prefix 811 together with a set of range start 819 and range end 821 values that specify ranges of suffix values as the mapping specifier. Each pair of start and end values (819(i),821(i)) corresponds to a range bitmap 823(i) that contains the bitmap which has been mapped onto the range of suffixes specified by the start and end values (819(i),821(i)). Where suffix values are sparsely distributed across the total range of suffix values, bitmap values of form 816 allows substantial reduction of the size of the bitmap value. Of course, the bitstrings in both implementations of ePC bitmap values may be compressed by means of any available lossless compression technique. Further, the range start and range end values may be used with extended mapping specifier prefixes like the one shown at 817.

ePC Bitmap Operations

The ePC bitmap operations are what one would expect given the nature of ePCs:
1. Conversion operations
   a. EPC_BITMAP2EPCS: This function converts an ePC bitmap value to the set of ePCs represented by the ePC bitmap value.
   b. EPCS2EPC_BITMAP: This function converts a set of ePCs to an ePC bitmap value.
   c. EPC_BITMAP2COUNT: This function converts an ePC bitmap value to the count of ePCs represented by the number of set bits in the ePC bitmap value.
2. The existence operation: EPC_BITMAP_EXISTS: This function returns 1 or 0 depending on whether a bit representing the given ePC(the second argument) is set in the ePC bitmap value (first argument).
3. Logical operations:
   a. EPC_BITMAP_AND: This function takes two ePC bitmap values and returns the AND of the bitmap values;
   b. EPC_BITMAP_OR: This function takes two ePC bitmap values and returns the OR of the bitmap values
   c. EPC_BITMAP_XOR: This function takes two ePC bitmap values and returns the XOR of the ePC bitmap values.
   d. EPC_BITMAP_MINUS: This function takes two ePC bitmap values and returns the first ePC bitmap value MINUS the second ePC bitmap value.
4. Changing the set of objects represented by an ePC bitmap value:
   a. EPC_BITMAP_INSERT: This function takes an ePC bitmap value and a set of ePCs and sets the bits in the bitmap value corresponding to the ePCs in the set.
   b. EPC_BITMAP_DELETE: This function takes an ePC bitmap value and a set of ePCs and resets the bits in the bitmap corresponding to the ePCs in the set.
5. Comparing two ePC bitmap values for equality: EPC_BITMAP_EQUALS: this function takes two ePC bitmap values and returns a value representing the logical value TRUE if the bitmap values represent the same set of ePCs and otherwise returns a value representing FALSE.
6. ePC bitmap value assignment: a source ePC bitmap value is assigned to a target ePC bitmap variable such as the value of an ePC bitmap field. At the end of the operation, the target has the source's value and class.

The operations work as described in the general discussion of bitmap operations. Where mapping specifiers specify ranges of suffix values, the operation may change the ranges as required to provide a result bitmap value which represents the entire result set of ePCs. In operations which convert a set of ePCs to an ePC bitmap value or modify the set of ePCs contained in an ePC bitmap value, the operation may include a parameter which specifies the number of bits in the ePCs which are to be considered prefix bits.

Applications of ePC Bitmap Values

Reducing the bandwidth required to transfer lists of ePCs across a network

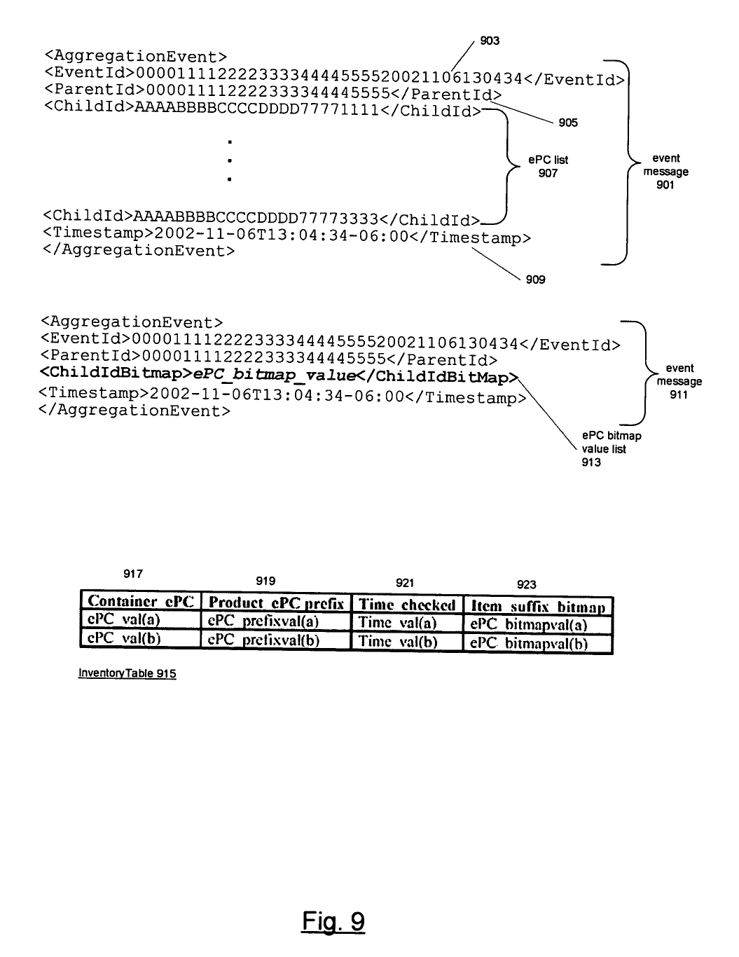

Inventory tracking with ePCs will be done with tracking devices that keep track of the ePCs of product items currently in a container such as a store shelf. The tracking devices will periodically send aggregation event messages indicating what product items are currently in the container to a central inventory database. Such messages are a species of event message in the inventory tracking system. FIG. 9 shows such an aggregation event message 901. The message is in XML. Message components are bounded by <component_name> . . . </component_name> and components may contain nested components. Event message 901 is an AggregationEvent. The next component of the message is an identifier 903 for the event. Then comes the identifier for the container which is the source of the event message. Next comes a list 907 of the ePCs for the product items currently in the container. Next comes a time stamp 909 indicating the time at which the list of ePCs was made.

When the container is any size at all, the list of the ePC's in the container becomes very long. With most inventory control being done with ePC's, the number of messages like message 901 becomes very large and presents a serious burden to the network that carries the message. Event message 911 shows how ePC bitmap values can be used to reduce the size of event messages involving lists of ePC's. As shown at 913, the list of ePCs 907 is replaced with a list of ePC bitmap values 913. Each item on the list has an ePC bitmap value with a mapping specifier that includes the ePC prefix 811 for one or more items in the container. The bits in the bitstring representation that correspond to the suffixes belonging to the items of the kind specified by the ePC prefix 811 are set. If all of the items in the container have the same prefix, there will be a single entry in ePC bitmap value list 913. Otherwise, there will be an entry for each ePC prefix for which there are items in the container.

Using ePC Bitmap Values in Database Management System Tables

In many cases, the aggregation event messages will be sent to central locations which use database management systems to keep track of inventory. ePC bitmap values can be used in tables in those central locations both to reduce the size of the tables and to speed the performance of many useful operations on ePCs. An example of such a table, InventoryTable 915 is shown in FIG. 9. The DDL that creates the table may look like this:

| CREATE TABLE InventoryTable | |
|---|---|
| (Container_EPC | RAW(12), |
| Product_EPC_prefix | RAW(12), |
| Time_checked | TIMESTAMP, |
| Item_suffix_bitmap | EPC96BITMAP); |

The table has four columns: Container_EPC 917, which contains an ePC for a container whose inventory is being controlled, Product_EPC_prefix 919, which is the object class 807 for ePCs representing items of a particular kind of product, Time_checked 921, which indicates when the products in the container indicated by field 917 that are of the kind indicated by field 919 were last checked, and Item_suffix_bitmap 923, which contains an ePC bitmap value that indicates which items of the products indicated by field 919 were in the container indicated by field 917 at the time indicated by field 921. As indicated by the type declaration for Item_suffix_bitmap, the sets of ePCs represented by the bitmap values contain 96-bit ePCs.

There are many ways in which the ePC bitmap operations can be used in table 915. For example, to find out how many items there are of a particular kind of product in a particular container, one could use the EPC_BITMAP2COUNT function like this:

```
item_count:= EPC_BITMAP962COUNT(TO_SET(
      SELECT Item_suffix_bitmap
        FROM InventoryTable
        WHERE (Container_EPC = container) AND
                (Product_EPC_prefix = prod_prefix)));
```

Where inventory information is coming in via aggregation event messages 911, the inventory table row for a particular container and product can be updated simply by assigning the aggregation message's time stamp to field 921 and its ePC bitmap for the particular container and product to field 923. In the course of updating, the bitmap logical operations can be used to detect changes between the old bitmap value of field 923 and the bitmap received in the aggregation event message. If the old bitmap value and the received bitmap value are XORed and the result bitstring has all “0” bits, there has been no change in the product items on the shelf XOR can thus be used to implement the EQUALS operation. EPC_BITMAP_OR can be used to sum the items of a product over the entire table and the COUNT function could be applied to the result of the summing OR operation to find the total number of the items present in the containers which have entries in the table. EPC_BITMAP_MINUS can be used to detect insertion and deletion of items. EPC_BITMAP_EXISTS can be used in queries to find what container an item indicated by a particular ePC is located in.

With aggregation event messages that contain lists of ePC's, the lists could be sorted by prefix and EPCS2EPC_BITMAP used to set field 923 for the container and product. Similarly, if the system that contained table 915 needed to provide a list of the ePC's for the items of a particular product in a particular container, it could do so by applying EPC_BITMAP2EPCS to field 923 for the container and product. If the aggregation event message reports simply the ePCs of items removed from the container or the ePCs of items added to the container, EPC_BITMAP_DELETE and EPC_BITMAP_INSERT can be used to update the bitmap values in field 923.

User-Defined Bitmap Data Types

As already pointed out, rowid bitmap values can represent any set of objects which it makes sense to store in one or more columns of a database table. There is thus no need for a user-defined bitmap data type that represents sets of objects stored in a database system. User-defined bitmap data types may, however be useful where the objects represented by the bitmap values are external to the database system. As previously set forth, all that is required for such a bitmap data type is an ordered set of identifiers. Other embodiments of the invention may permit the user to define a set of identifiers in the database system and a bitmap data type based on the set of identifiers. The definition of the bitmap data type would involve defining the mapping specifier for the bitmap data type, defining the bit string representation for the data type, and the semantics of the operations on values of the bitmap data type.

Conclusion

The foregoing Detailed Description has disclosed to those skilled in the relevant technologies how to make and use the bitmap values of the invention and has further disclosed the best modes presently known to the inventors of so doing. It will be immediately apparent that many variations on the techniques disclosed herein are possible. For example, in the bitmap values disclosed herein, the presence of an object in the set represented by the bitmap value is marked by setting a bit in the bitstring to 1; otherwise, the bit is set to 0; in some embodiments, this may be reversed, with the bit being set to 0 if the object is present and otherwise to 1. The bits in the bitstring and the ranges in the range specifiers may be represented in other embodiments by any technique which is convenient to the purpose; in particular, any compression method may be applied to the bitmap value's bitstring which preserves the information contained in the bitstring concerning the presence of objects in the set. The techniques described herein with regard to bitmap values that represent sets of rowids and sets of ePCs may be usefully applied to make and use bitmap values that represent any large set of ordered objects. How such bitmap values are used will of course depend on the domain that the objects represented by the bitmap values belong to. Bitmap values representing rowids may be used in database management systems not only to construct user-defined indexes, but also for any purpose for which it is useful to maintain a compact representation of a set of rowids. Versions of the disclosed bitmap operations which have different semantics or syntax than the ones described herein may be made. Moreover, because the kinds of operations required depend on the objects represented by the bitmap values, other embodiments may define and use operations on bitmap values other than the ones described herein. For all of the foregoing reasons, the Detailed Description is to be regarded as being in all respects exemplary and not restrictive, and the breadth of the invention disclosed here in is to be determined not from the Detailed Description, but rather from the claims as interpreted with the full breadth permitted by the patent laws.

1. A database management system having the improvement comprising:
bitmap values, a bitmap value having a representation of a bitstring wherein set bits specify a set of objects whose definitions are built into the database management system, and user-accessible operations on the bitmap values.

2. The database management system set forth in claim 1 wherein the user-accessible operations comprise at least:
a set-to-bitmap operation wherein a bitmap value is derived from a given set of the objects.

3. The database management system set forth in claim 2 wherein:
the derived bitmap value is a new bitmap value that specifies the objects in the given set.

4. The database management system set forth in claim 2 wherein:
the derived bitmap value is a preexisting bitmap value which now further specifies the objects in the given set.

5. The database management system set forth in claim 2 wherein:
the derived bitmap value is a preexisting bitmap value which now no longer specifies any objects in the given set.

6. The database management system set forth in claim 1 wherein the user-accessible operations comprise at least:
a bitmap-to-set operation wherein the set of the objects specified in a given bitmap value is derived from the given bitmap value.

7. The database management system set forth in claim 1 wherein the user-accessible operations comprise at least:
a bitmap-to-count operation wherein the number of the objects in the set specified in a given bitmap value is derived from the given bitmap value.

8. The database management system set forth in claim 1 wherein the user-accessible operations comprise at least:
an existence operation wherein a value representing the logical value TRUE is returned when a given object belongs to the set of the objects represented by a given bitmap value.

9. The database management system set forth in claim 1 wherein the user-accessible operations comprise at least:
a logical operation on a first bitstring represented by a first bitmap value and a second bitstring represented by a second bitmap value.

10. The database management system set forth in claim 1 wherein the user-accessible operations comprise at least:
a comparison operation on a first bitmap value and a second bitmap value wherein a value representing the logical value TRUE is returned when the first bitmap value and the second bitmap value specify the same set of the objects.

11. The database management system set forth in claim 1 wherein:
the bitmap values include settable bitmap values; and
the user-accessible operations comprise at least an assignment operation which sets a target settable bitmap value from a source bitmap value.

12. The database management system set forth in claim 1 wherein:
the bitmap values include bitmap values that are persistent in the database management system.

13. The database management system set forth in claim 12 wherein:
the persistent bitmap values include bitmap values in fields of tables of the database management system.

14. The database management system set forth in claim 1 wherein:
the bitstring is compressed.

15. The database management system set forth in claim 1 wherein:
the objects are identifiers for other objects that exist in the database management system.

16. The database management system set forth in claim 15 wherein:
the identifiers for the other objects are row identifiers of rows in the database management system.

17. The database management system set forth in claim 16 wherein:
the row identifiers are row identifiers returned by a user-defined query executed in the database management system.

18. The database management system set forth in claim 17 wherein:
the query returns a row identifier when a field in the row has an attribute specified in the query,
whereby the bitmap value represents the set of fields having the specified attribute.

19. The database management system set forth in claim 1 wherein:
the objects are identifiers for other objects that exist outside the database management system.

20. The database management system set forth in claim 19 wherein:
the identifiers for objects that exist outside the database management system are electronic product codes for product items.

21. A data storage device, the data storage device being characterized in that:
the data storage device contains code which, when executed in a computer system, implements the database management system set forth in claim 1.

22. A bitmap value employed in a database management system, the bitmap value representing a first set of first objects, the first objects being external to the database management system and members of the first set being mapped onto a members of a second set of second objects that is defined in the database management system, and
the bitmap value comprising:
a mapping specifier that maps a string of bits to a subset of the second set; and
a representation of the string of bits wherein a bit is set in the represented string of bits when the member of the second set that is mapped to the bit has a member of the first set mapped thereto.

23. The bitmap value set forth in claim 22 wherein:
the second set is ordered.

24. The bitmap value set forth in claim 23 wherein:
the order of the members of the second ordered set corresponds to values of the members thereof;
the mapping specifier specifies the mapping by specifying one or more ranges of the values of the members of the second ordered set to which the string of bits is mapped; and
the representation of the string of bits represents strings of bits corresponding to the ranges.

25. The bitmap value set forth in claim 24 wherein:
the mapping specifier specifies the range of the values by specifying a start value and an end value.

26. The bitmap value set forth in claim 24 wherein:
the values include a prefix which determines a range of the values; and
the mapping specifier specifies the range of the values by specifying the prefix for the range.

27. The bitmap value set forth in claim 26 wherein:
the mapping specifier further specifies the range of the values by using a start value and an end value to specify one or more subranges of the range specified by the prefix.

28. The bitmap value set forth in claim 24 wherein:
the objects in the second ordered set are identifiers for objects in the first set.

29. The bitmap value set forth in claim 28 wherein:
the identifiers for objects in the first set are electronic product codes for the objects

30. The bitmap value set forth in claim 22 wherein:
there is a plurality of the bitmap values in the database management system; and certain of the bitmap values are persistent in the database management system.

31. The bitmap values set forth in claim 30 wherein:
the persistent bitmap values include bitmap values in fields of tables of the database management system.

32. The bitmap value set forth in claim 22 wherein:
the representation of the bitstring is a compressed representation thereof.

33. The bitmap value set forth in claim 22 wherein:
there is a plurality of the bitmap values in the database management system; and
the database management system provides a plurality of user-accessible operations on the bitmap values.

34. The bitmap value set forth in claim 33 wherein:
certain of the user-accessible operations alter the range specifier and the representation of the bitstring as required to map the represented string of bits to a subset of the second set that is required for the operation.

35. A data storage device, the data storage device being characterized in that:
the data storage device contains code which, when executed in a computer system, implements the bitmap value set forth in claim 22.

36. A method employed in a database system of making a bitmap value that represents a first set of objects external to the database system,
the method comprising the steps performed in the database system of:
mapping the objects onto a second ordered set of identifiers defined in the database management system;
mapping a bitstring that is represented in the bitmap value onto a subset of the second set that includes the identifiers onto which the objects have been mapped; and
setting the bits in the bitstring that correspond to the identifiers onto which the objects have been mapped.

37. The method set forth in claim 36 wherein:
in the step of mapping the objects, the identifiers in the second set are identical with identifiers that are employed externally to the database system to identify the objects.

38. The method set forth in claim 37 wherein:
in the second set, the identifiers are electronic product codes.

39. The method set forth in claim 36 wherein the step of mapping a bitstring comprises the steps of:
making a range specifier that specifies a range of the ordered set of identifiers that includes the identifiers into which the objects have been mapped; and
mapping the bits in the bitstring to the specified range.

40. The method set forth in claim 39 wherein the step of making a range specifier includes the step of:
making a start value and an end value which together specify the range.

41. The method set forth in claim 39 wherein the step of making a range specifier includes the step of
making a prefix value which specifies the range.

42. The method set forth in claim 36 further comprising the step of:
compressing the bitstring.

43. A data storage device, the data storage device being characterized in that:
the data storage device contains code which, when executed in a computer system, implements the method set forth in claim 36.

44. A bitmap value employed in a database management system to represent a first subset of the row identifiers defined in the database management system,
the bitmap value comprising:
a mapping specifier that maps a string of bits to a second subset of the set of row identifiers; and
a representation of the string of bits wherein a bit is set in the represented string of bits when the member of the second subset that is mapped to the bit corresponds to a member of the first subset; and
the first subset is returned by a user-defined query executed by the database management system

45. The bitmap value set forth in claim 44 wherein:
the database management system dynamically alters the mapping specifier and the representation of the string of bits as required to map the representation of the string of bits to a second subset of the row identifiers that includes the first subset of the row identifiers.

46. The bitmap value set forth in claim 44 wherein:
the query returns a row identifier when a field in the row identified by the row identifier has an attribute specified in the query,
whereby the bitmap value represents the set of fields whose values have the specified attribute.

47. A data storage device, the data storage device being characterized in that:
the data storage device contains code which, when executed in a computer system, implements the method set forth in claim 44.

48. A method of reducing the size of a list of electronic product codes,
the method comprising the steps of:
making a bitmap value that includes a range specifier and a bitstring representation, the range specifier specifying a range of the electronic product codes that includes one or more electronic product codes on the list and the bitstring representation representing a bitstring that is mapped onto the specified range and
setting a bit in the bitstring representation when the bit corresponds to an included electronic product code.

49. The method set forth in claim 48 further comprising the step of:
compressing the bitstring representation.

50. The method set forth in claim 48 wherein:
the range specifier includes a prefix that is shared by the one or more electronic product codes.

51. A data storage device, the data storage device being characterized in that:
the data storage device contains code which, when executed in a computer system, implements the method set forth in claim 48.

52. A representation of a set of electronic product codes for use in a digital system that transfers or processes electronic product codes,
the representation comprising:
a range specifier that specifies a range of electronic product codes that includes the members of the set; and
a bitstring representation that represents a bitstring whose bits have been mapped onto the range specified by the range specifier, a bit being set in the represented bit string when the bit corresponds to a member of the set.

53. The representation of the set of electronic product codes set forth in claim 52 wherein:
the range specifier includes a prefix which is shared by the members of the set.

54. The representation of the set of electronic product codes set forth in claim 52 wherein:
the bitstring representation is a compressed representation of the bitstring.

55. A data storage device, the data storage device being characterized in that:
the data storage device contains code which, when executed in a computer system, implements the representation of the set of electronic product codes set forth in claim 52.

56. A method of indexing a set of objects contained in fields of an object column of a first table in a database management system, the indexing being done according to attributes that apply to the objects and
the method comprising the steps of:
constructing a second table in the database management system, the second table having columns including
an attribute specifier column whose fields specify attributes according to which the indexing is being done and
a bitmap column whose fields contain bitmap values including bit string representations representing bit strings that are mapped onto row identifiers identifying rows of the first table; and
for each row of the second table,
using the attribute specified in the row to query the first table to determine row identifiers of rows of the first table whose object column fields satisfy the attribute specified in the row and
in the row's bitmap value, setting the bits corresponding to the determined row identifiers in the bitstring represented by the bitmap value's bitstring representation.

57. A data storage device, the data storage device being characterized in that:
the data storage device contains code which, when executed in a computer system, implements the method set forth in claim 56.
